(19) United States
(12) Patent Application Publication
(10) Pub. No.: US 2025/0365393 A1
(43) Pub. Date: Nov. 27, 2025

(54) METHOD, APPARATUS AND SYSTEM FOR CONTROLLING VEHICLE CAMERAS TO GENERATE VIDEOS

(71) Applicant: CARIAD (China) Co., Ltd., Beijing (CN)

(72) Inventor: Yan CHEN, Beijing (CN)

(21) Appl. No.: 19/178,771

(22) Filed: Apr. 14, 2025

(30) Foreign Application Priority Data
Apr. 18, 2024 (CN) 202410469340.2

(51) Int. Cl. H04N 7/18; B60R 1/28; B60R 1/29; G06V 20/59; G06V 40/16; H04N 23/667; H04N 23/698; H04N 23/90

(52) U.S. Cl. CPC H04N 7/188; G06V 20/597; G06V 40/166; H04N 23/667; H04N 23/698; H04N 23/90; B60R 1/28; B60R 1/29; B60R 2300/105; B60R 2300/303

(57) ABSTRACT

Provided are a method, apparatus, and system for controlling vehicle cameras to generate videos, the method comprising: acquiring driving information of the vehicle and preset matching information, wherein the driving information comprises at least driving direction information and braking status information of the vehicle, and the preset matching information comprises first matching information which defines a matching relationship between the driving direction information and/or braking status information of the vehicle and activation of a corresponding vehicle camera; and according to the first matching information, selecting and activating the corresponding vehicle camera among a plurality of vehicle cameras on the basis of the driving direction information and/or braking status information of the vehicle to shoot an exterior or interior of the vehicle to generate the video. Thus, the shooting camera can be automatically adjusted according to the driving direction and/or braking status, thereby increasing driving video shooting modes, meeting users' needs for shooting in diversified directions, and providing users with driving videos featuring richer content.

### TECHNICAL FIELD

The present disclosure relates to the technical field of in-vehicle shooting, and in particular, to a method, apparatus, and system for controlling vehicle cameras to generate videos, a corresponding electronic device, computer-readable storage medium, and vehicle.

### BACKGROUND

With the rapid development of vehicle technology, vehicle functions have been continuously enriched. On the basis of meeting daily travel needs, many new entertainment functions have been added, significantly improving the driving and riding experience.

Controlling vehicle cameras to shoot videos of scenery during driving for sharing has become a way for users to share their daily lives. Existing vehicle video shooting methods typically utilize a front camera or a camera manually selected by a user for single-direction shooting. Although the scenery on one side of the vehicle can be captured, images in other directions around the vehicle during driving are often neglected. In this way, a single shooting method fails to meet the user's needs for shooting in different directions during driving.

Therefore, there is a need for an improved solution for controlling vehicle cameras to perform shooting.

### SUMMARY

In view of this, the present disclosure provides a method, apparatus, and system for controlling vehicle cameras to generate videos, a corresponding electronic device, computer-readable storage medium, and vehicle.

In a first aspect, the present disclosure provides a method for controlling a vehicle camera to generate a video, the method comprising:
acquiring driving information of the vehicle and preset matching information, wherein the driving information comprises at least driving direction information and braking status information of the vehicle, and the preset matching information comprises first matching information which defines a matching relationship between the driving direction information and/or braking status information of the vehicle and activation of a corresponding vehicle camera; and
according to the first matching information, controlling the activation of the corresponding vehicle camera among a plurality of vehicle cameras on the basis of the driving direction information and/or braking status information of the vehicle to shoot an exterior or interior of the vehicle to generate a video.

In one embodiment, the driving information further comprises driving speed information of the vehicle, and the preset matching information comprises second matching information which defines a matching relationship between the driving speed information of the vehicle and activation of a corresponding shooting mode. The method further comprises: according to the second matching information, controlling the activation of the corresponding shooting mode among a plurality of shooting modes of the corresponding vehicle camera on the basis of the driving speed information of the vehicle.

In one embodiment, the method further comprises: acquiring facial recognition information of a vehicle user inside the vehicle; determining a direction of interest of the vehicle user on the basis of the facial recognition information; and when the direction of interest of the vehicle user is inconsistent with a shooting direction of the corresponding selected and activated vehicle camera, additionally selecting and activating a vehicle camera whose shooting direction is consistent with the direction of interest of the vehicle user.

In one embodiment, the first matching information defines the matching relationship between the driving direction information and/or braking status information of the vehicle and the activation of the corresponding vehicle camera by:
activating a vehicle left-side camera when the driving direction of the vehicle is a right-turn direction;
activating a vehicle right-side camera when the driving direction of the vehicle is a left-turn direction;
activating a vehicle rear-side camera when the driving direction of the vehicle is a reverse direction;
activating a vehicle front-side camera when the driving direction of the vehicle is a forward direction; or
activating a vehicle interior camera when the vehicle is in a braking status.

In one embodiment, the second matching information defines the matching relationship between the driving speed information of the vehicle and the activation of the corresponding shooting mode by:
activating a time-lapse shooting mode when the driving status is acceleration;
activating a slow-motion shooting mode when the driving status is deceleration;
activating an A-times speed shooting mode when the driving status is high-speed driving, wherein A is greater than 1;
activating a B-times speed shooting mode when the driving status is medium-speed driving, wherein B is greater than 1 and less than A;
activating a normal shooting mode when the driving status is low-speed driving; or
activating a freeze-frame shooting mode when the driving status is braking.

In one embodiment, the method further comprises: controlling to enter a panoramic generation mode after acquiring an operation instruction for generating a panoramic video; in the panoramic generation mode, at least activating all vehicle exterior cameras to perform video shooting on the exterior of the vehicle to generate a plurality of videos; and stitching the plurality of videos into a panoramic video using a video stitching algorithm.

In a second aspect, the present disclosure provides an apparatus for controlling a vehicle camera to generate a video, the apparatus comprising: an information acquisition module, configured to acquire driving information of the vehicle and preset matching information, wherein the driving information comprises at least driving direction information and braking status information of the vehicle, and the preset matching information comprises first matching information which defines a matching relationship between the driving direction information and/or braking status information of the vehicle and activation of a corresponding vehicle camera; and a video generation control module, configured to, according to the first matching information, control the activation of the corresponding vehicle camera among a plurality of vehicle cameras on the basis of the driving direction information and/or braking status information of the vehicle to shoot an exterior or interior of the vehicle to generate a video.

In one embodiment, the driving information further comprises driving speed information of the vehicle, and the preset matching information comprises second matching information which defines a matching relationship between the driving speed information of the vehicle and activation of a corresponding shooting mode. The apparatus further comprises: a shooting mode activation module, configured to, according to the second matching information, select and activate the corresponding shooting mode among a plurality of shooting modes of the corresponding vehicle camera on the basis of the driving speed information of the vehicle.

In one embodiment, the apparatus further comprises: a facial recognition information acquisition module, configured to acquire facial recognition information of a vehicle user inside the vehicle; and a direction of interest determination module, configured to determine a direction of interest of the vehicle user on the basis of the facial recognition information, wherein the video generation control module is further configured to, when the direction of interest of the vehicle user is inconsistent with a shooting direction of the corresponding selected and activated vehicle camera, additionally select and activate a vehicle camera whose shooting direction is consistent with the direction of interest of the vehicle user.

In one embodiment, the video generation control module is further configured to: control to enter a panoramic generation mode after acquiring an operation instruction for generating a panoramic video; and in the panoramic generation mode, at least activate all vehicle exterior cameras to perform video shooting on the exterior of the vehicle to generate a plurality of videos; and the apparatus further comprises a video stitching module which is configured to stitch the plurality of videos into a panoramic video using a video stitching algorithm.

In a third aspect, the present disclosure provides a system for controlling a vehicle camera to generate a video, which may comprise a cloud platform and an apparatus for controlling a vehicle camera to generate a video as described herein.

In a fourth aspect, the present disclosure provides an electronic device which comprises a processor and a memory storing computer program instructions which, when executed by the processor, implement the steps of a method for controlling a vehicle camera to generate a video as described herein.

In a fifth aspect, the present disclosure provides a computer-readable storage medium storing a computer-executable program which, when executed by a processor, implements the steps of a method for controlling a vehicle camera to generate a video as described herein.

In a sixth aspect, the present disclosure provides a vehicle which may comprise a plurality of vehicle cameras and an apparatus for controlling a vehicle camera to generate a video as described herein.

The method, apparatus, system for controlling a vehicle camera to generate a video, the corresponding electronic device, computer-readable storage medium, and vehicle according to the present disclosure have at least the following advantageous effects: by the preset matching information and an intelligent camera selection mechanism, a camera can be automatically selected and activated for shooting according to the driving direction information and/or braking status information of the vehicle during driving. This increases the driving video shooting methods while ensuring driving safety, thereby meeting users' needs for shooting in diversified directions and providing users with driving videos featuring richer content. By selecting and activating a camera in an appropriate direction according to different driving statuses and braking status information, the generated video content can focus more on environmental images or human images that undergo significant variations during driving, thereby making the generated video more vivid and shareable.

### BRIEF DESCRIPTION OF THE DRAWINGS

To more clearly illustrate specific embodiments of the present disclosure, the specific embodiments are further described below with reference to the drawings.

FIG. 1 shows a schematic structural diagram of a system for controlling a vehicle camera to generate a video according to an embodiment of the present disclosure;

FIG. 2 shows a schematic diagram of a position of a vehicle exterior camera according to an embodiment of the present disclosure;

FIG. 3 is a schematic flowchart of a method for controlling a vehicle camera to generate a video according to an embodiment of the present disclosure;

FIG. 4 is a schematic structural diagram of an apparatus for controlling a vehicle camera to generate a video according to an embodiment of the present disclosure; and

FIG. 5 is a schematic structural diagram of an electronic device according to an embodiment of the present disclosure.

### DETAILED DESCRIPTION OF THE EMBODIMENTS

To make features and advantages described above and others of the present disclosure clearer, the present disclosure is further described below with reference to the drawings. It is to be understood that the specific embodiments presented herein are merely illustrative and provided solely for explanation to those skilled in the art, and are not to be construed as limiting.

In the following description, numerous specific details are set forth to provide a thorough understanding of the present disclosure. However, it is apparent to those skilled in the art that the present disclosure can be practiced without the need for specific details. In other cases, well-known steps or operations are not described in detail to avoid obscuring the present disclosure.

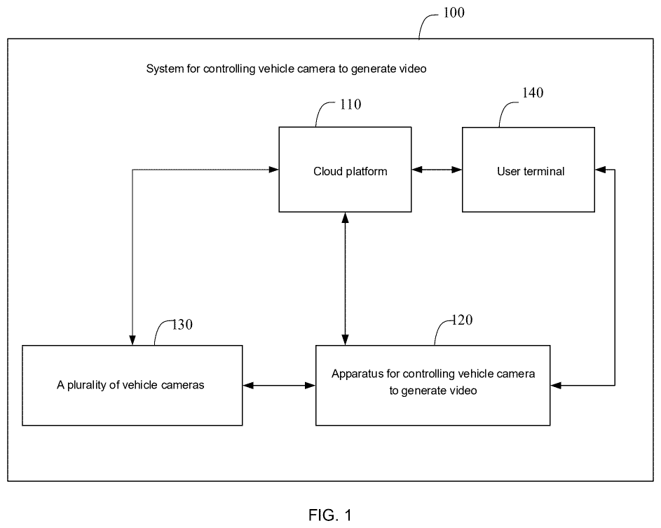

FIG. 1 shows a schematic structural diagram of a system for controlling a vehicle camera to generate a video according to an embodiment of the present disclosure. As shown in FIG. 1, the system 100 for controlling a vehicle camera to generate a video may comprise a cloud platform 110 and an apparatus 120 for controlling a vehicle camera to generate a video. Preferably, the system may further comprise a plurality of vehicle cameras 130.

The cloud platform 110 may be referred to as a cloud computing platform, capable of providing a variety of remote services for vehicle users. In one embodiment, the cloud platform 110 is in data communication with the apparatus 120 for controlling a vehicle camera to generate a video via a communication network. The cloud platform 110 may be configured to receive and store videos shot by the vehicle camera and processed videos of subsequent processing.

In one embodiment, the cloud platform 110 may further be configured to store preset matching information and transmit the matching information to the apparatus 120 for controlling a vehicle camera to generate a video. The matching information may comprise default matching information and personalized matching information. The default matching information and the personalized matching information may both comprise first matching information and second matching information, as described in more detail below.

The apparatus 120 for controlling a vehicle camera to generate a video is connected to the vehicle camera 130 and can control the activation and deactivation of the plurality of vehicle cameras, as well as shooting modes of the vehicle cameras.

The apparatus 120 for controlling a vehicle camera to generate a video performs steps of the method for controlling a vehicle camera to generate a video of any one of the embodiments provided herein, thereby intelligently activating the vehicle cameras matching the driving information of the vehicle to increase the shooting methods of the driving videos, enable the shooting of scenery in different directions during driving, acquire driving videos featuring richer content, and solve the problem of a single shooting method failing to meet the user's needs for shooting in different directions.

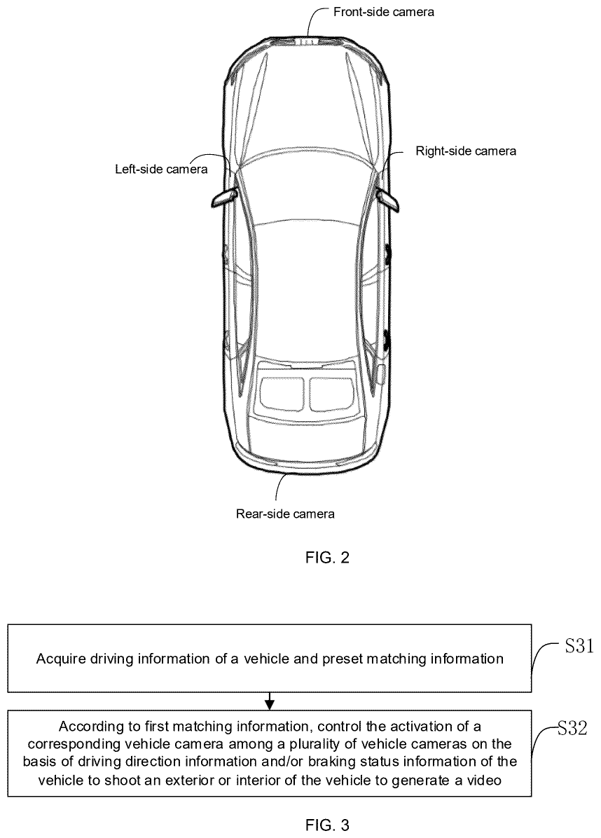

The plurality of vehicle cameras 130 may comprise vehicle interior cameras and vehicle exterior cameras located at different locations outside the vehicle. FIG. 2 shows a schematic diagram of a position of a vehicle exterior camera according to an embodiment of the present disclosure. As shown in FIG. 2, the vehicle exterior camera may comprise at least a vehicle front-side camera, a vehicle left-side camera, a vehicle right-side camera, and a vehicle rear-side camera. In addition, the vehicle exterior camera may further comprise a top camera and a bottom camera.

It is to be noted that the vehicle exterior cameras are not limited to the positions shown in FIG. 2, and there may be more than one camera on each side of the vehicle.

In some embodiments, as shown in FIG. 1, the system 100 for controlling a vehicle camera to generate a video may further comprise a user terminal 140. The user terminal 140 may generate personalized matching information according to a setting operation of the vehicle user in an application program or on a web page, and synchronize the personalized matching information with the apparatus 120 for controlling a vehicle camera to generate a video and with the cloud platform 110.

The user terminal 140 may receive a video generated by a vehicle camera. The user terminal 140 may further edit an original video into a processed video according to a video template of interest to the user.

It is to be noted that the original video and the processed video can be displayed not only on a display screen at an in-vehicle terminal but also on the user terminal 140. The user terminal 140 may be, for example, an electronic device such as a mobile phone, a tablet, a laptop, a smart wearable device, or the like.

In some embodiments, the apparatus 120 for controlling a vehicle camera to generate a video or the user terminal 140 may share the original video and/or the processed video on the Internet through a sharing operation of the user. The sharing operation may be a page operation, a voice operation, or the like. In this way, by sharing videos externally, social behavior is increased.

Another aspect of the present disclosure provides a method for controlling a vehicle camera to generate a video, which can be applied to the apparatus 120 for controlling a vehicle camera to generate a video as shown in FIG. 1. FIG. 3 is a schematic flowchart of a method for controlling a vehicle camera to generate a video according to an embodiment of the present application. As shown in FIG. 3, the method for controlling a vehicle camera to generate a video may comprise the following steps.

At S31, driving information of a vehicle and preset matching information are acquired.

The “driving information” involved herein may be a collection of various types of information related to the driving process of the vehicle, and may include, but is not limited to, real-time driving information and predicted driving information. The real-time driving information can reflect the real-time driving situation of the vehicle during driving. The predicted driving information can reflect the future driving situation of the vehicle during driving.

In one embodiment, the driving information comprises at least driving direction information and braking status information of the vehicle. The braking status information reflects the braking condition of the vehicle. In the embodiments of the present disclosure, the braking status information may comprise real-time braking status information and predicted braking status information. The real-time braking status information can reflect whether the vehicle is currently in braking status. The predicted braking status information can reflect whether the vehicle is expected to be in braking status in the future.

The driving direction information describes the driving trajectory and the driving direction of the vehicle on the road. In the embodiments of the present disclosure, the driving direction information may comprise real-time driving direction information and predicted driving direction information. The real-time driving direction information can reflect the current actual driving direction and driving trajectory of the vehicle. The predicted driving direction information can reflect the future driving trajectory and driving direction of the vehicle.

It is to be noted that the predicted driving information can be obtained on the basis of a comprehensive analysis of the real-time driving information of the vehicle, as well as information such as road conditions, traffic conditions, and the like.

Furthermore, the “preset matching information” involved herein may be stored in advance in the cloud platform 110 or the apparatus 120 for controlling a vehicle camera to generate a video.

The preset matching information may be rule conditions set for shooting videos with rich content or videos desired by the user during driving. In one embodiment, the preset matching information may comprise first matching information. The first matching information defines the matching relationship between the driving direction information and/or braking status information of the vehicle and the activation of the corresponding vehicle camera. In particular, the driving direction of the vehicle may include, but is not limited to, a left-turn direction, a right-turn direction, a reverse direction, a forward direction, and the like.

At S32, according to the first matching information, a corresponding vehicle camera among a plurality of vehicle cameras is selected and activated on the basis of the driving direction information and/or braking status information of the vehicle to shoot an exterior or interior of the vehicle to generate the video.

In one embodiment of the present disclosure, the apparatus 120 for controlling a vehicle camera to generate a video searches for the corresponding vehicle camera in the first matching information according to the driving direction information and/or braking status information of the vehicle. According to the search result, the apparatus 120 for controlling a vehicle camera to generate a video selects and activates the corresponding vehicle camera. Once activated, this corresponding vehicle camera shoots the external or internal environment of the vehicle at the corresponding position.

It is to be noted that when the driving information of the vehicle does not vary, the apparatus 120 for controlling a vehicle camera to generate a video may not switch the vehicle camera. When the driving information of the vehicle varies, the apparatus 120 for controlling a vehicle camera to generate a video switches the vehicle camera. Also, when the vehicle is parked, the vehicle camera may stop shooting.

In some embodiments, the step S32 above may be performed to, according to the first matching information, select and activate the corresponding vehicle camera among the plurality of vehicle cameras on the basis of the real-time driving direction information and/or real-time braking status information of the vehicle.

In particular, the apparatus 120 for controlling a vehicle camera to generate a video acquires real-time driving direction information and real-time braking status information of the vehicle in the current driving area. According to the first matching information, the corresponding camera is accurately selected and activated, on the basis of the real-time driving direction information and/or real-time braking status information, to shoot the exterior or interior of the vehicle to generate a video.

For example, when the vehicle enters a left turn lane and the real-time driving direction information indicates a left turn, the apparatus 120 for controlling a vehicle camera to generate a video selects and activates the vehicle right-side camera corresponding to the left-turn direction, thereby allowing for better real-time shooting of the curve scenery.

In some embodiments, the first matching information defines the matching relationship between the driving direction information and/or braking status information of the vehicle and the activation of the corresponding vehicle camera by: activating a vehicle left-side camera when the driving direction of the vehicle is a right-turn direction; activating a vehicle right-side camera when the driving direction of the vehicle is a left-turn direction; activating a vehicle rear-side camera when the driving direction of the vehicle is a reverse direction; activating a vehicle front-side camera when the driving direction of the vehicle is a forward direction; or activating a vehicle interior camera when the vehicle is in a braking status.

In particular, when the driving direction information indicates that the driving direction of the vehicle is the right-turn direction, the first matching information may instruct activation of the vehicle left-side camera. Since the vehicle user pays close attention to the road conditions on the left side when turning right, to meet the focus of the vehicle user during the right turn of the vehicle, the apparatus activates the vehicle left-side camera to shoot and capture the image of this area.

When the driving direction information indicates that the driving direction of the vehicle is the left-turn direction, the first matching information may instruct activation of the vehicle right-side camera. Since the vehicle user pays close attention to the road conditions on the right side when turning left, to meet the focus of the vehicle user during the left turn of the vehicle, the apparatus activates the vehicle right-side camera to shoot and capture the image of this area.

When the driving direction information indicates that the driving direction of the vehicle is the reverse direction, the first matching information may instruct activation of the vehicle rear-side camera to better observe the situation behind the vehicle.

When the driving direction information indicates that the driving direction of the vehicle is the forward direction, the first matching information may instruct activation of the vehicle front-side camera to better observe the situation ahead of the vehicle.

When the braking status information indicates braking status, the first matching information may instruct activation of the vehicle interior camera to capture the status of the user inside the vehicle under the braking status.

In the embodiments above, by defining the first matching information, the activated camera can meet the requirements of different driving scenarios and braking scenarios, ensuring that the vehicle user obtains the most desired external or internal field of view of the vehicle. Certainly, the first matching information may also be set differently according to the preferences of the user.

In some embodiments, the step S32 above may be performed to, according to the first matching information, select and activate a corresponding vehicle camera among a plurality of vehicle cameras in advance on the basis of the predicted driving direction information and/or predicted braking status information of the vehicle to shoot an exterior or interior of the vehicle to generate a video.

In particular, the apparatus 120 for controlling a vehicle camera to generate a video acquires the predicted driving direction information and/or predicted braking status information of the next driving area the vehicle is about to enter. According to the first matching information, the corresponding camera is selected and activated in advance on the basis of the predicted driving direction information and/or the brake status prediction information to shoot the exterior or interior of the vehicle to generate the video. In this way, it not only allows for better capture of the environment on the upcoming road, but also enables comprehensive capture of important braking processes or accident scenes at critical moments.

For example, when the vehicle is about to enter a left turn lane and the predicted driving direction information indicates that a left turn is about to be made, the apparatus 120 for controlling a vehicle camera to generate a video selects and activates the vehicle camera corresponding to the left-turn direction in advance, thereby allowing for better capture of road conditions and obstacles in the curve.

When the predicted braking status information indicates that the braking status is expected in the future, the apparatus 120 for controlling a vehicle camera to generate a video selects and activates the vehicle camera corresponding to the braking status in advance, thereby allowing for a comprehensive shoot of the braking process and potential collision situations.

For example, during a complete drive, the vehicle speed may vary. By varying the shooting speed of the vehicle camera in accordance with the vehicle speed variation, the excitement of the video can be increased, and the interest of the video can be enhanced. In some embodiments, the driving information further comprises driving speed information of the vehicle. The preset matching information comprises not only first matching information but also second matching information. The second matching information defines a matching relationship between the driving speed information of the vehicle and the activation of a corresponding shooting mode.

The “driving speed information” herein may comprise a vehicle driving speed and speed variation status. The vehicle driving speed may be a real-time driving speed or a predicted driving speed. The real-time driving speed can reflect the real-time vehicle speed and the real-time vehicle speed variation. The predicted driving speed can reflect the vehicle speed and vehicle speed variation over a future period of time. The vehicle speed variation status can be reflected by acceleration. For example, when the acceleration is positive, the vehicle is in accelerating status, and when the acceleration is negative, the vehicle is in decelerating status.

The shooting mode of each vehicle camera may comprise a plurality of parameter setting items, such as frame rate, resolution, field of view, exposure, and the like. Different setting parameters can result in different shooting modes.

The method for controlling a vehicle camera to generate a video may further comprise: according to the second matching information, selecting and activating a corresponding shooting mode among a plurality of shooting modes of the corresponding vehicle camera on the basis of the driving speed information of the vehicle.

The “a plurality of shooting modes” involved herein may comprise a high-speed shooting mode, a medium-speed shooting mode, a low-speed shooting mode, a braking shooting mode, an acceleration shooting mode, and a deceleration shooting mode. Each shooting mode corresponds to one vehicle driving speed or one speed variation status. The plurality of shooting modes can meet the shooting needs in different speed scenarios.

The corresponding shooting mode may be a shooting mode matching the driving speed information of the vehicle. The plurality of shooting modes may comprise all shooting modes in the second matching information. The corresponding shooting mode may be one of the plurality of shooting modes.

In one embodiment of the present disclosure, when according to the first matching information, selecting and activating a corresponding vehicle camera among a plurality of vehicle cameras on the basis of the driving direction information and/or braking status information of the vehicle, the apparatus 120 for controlling a vehicle camera to generate a video can search for the corresponding shooting mode in the second matching information according to the driving speed information of the vehicle. According to the search result, the corresponding shooting mode of the corresponding camera is activated to shoot the exterior or interior of the vehicle to generate the video.

In the embodiments above, by activating the corresponding shooting mode of the corresponding camera to shoot for video generation, the vehicle can adopt appropriate shooting modes for shooting under different vehicle speed scenarios, forming a video with varying styles, thereby enhancing the interest of the video and increasing the excitement of the video.

In one embodiment, according to the second matching information, the apparatus 120 for controlling a vehicle camera to generate a video selects and activates the corresponding shooting mode among a plurality of shooting modes of the corresponding vehicle camera on the basis of the real-time driving speed of the vehicle. In this way, the apparatus 120 for controlling a vehicle camera to generate a video can adjust the shooting mode of the camera in real time according to the driving speed of the vehicle or the vehicle speed variation, ensuring that high-quality video shootings can be obtained under any scenario.

In another embodiment, according to the second matching information, the apparatus 120 for controlling a vehicle camera to generate a video selects and activates the corresponding shooting mode among the plurality of shooting modes of the corresponding vehicle camera in advance on the basis of the predicted driving speed of the vehicle. In this way, the method of selecting the shooting mode in advance on the basis of the predicted driving speed can respond to the vehicle status in advance, enabling the apparatus 120 for controlling a vehicle camera to generate a video to more actively and intelligently adapt to different driving scenarios and needs.

In some embodiments, the second matching information defines the matching relationship between the driving speed information of the vehicle and the activation of the corresponding shooting mode by: activating a time-lapse shooting mode when the driving status is acceleration; activating a slow-motion shooting mode when the driving status is deceleration; activating an A-times speed shooting mode when the driving status is high-speed driving, wherein A is greater than 1; activating a B-times speed shooting mode when the driving status is medium-speed driving, wherein B is greater than 1 and less than A; activating a normal shooting mode when the driving status is low-speed driving; or activating a freeze-frame shooting mode when the driving status is a braking status.

In particular, for example, when the driving speed information of the vehicle indicates that the vehicle is in the acceleration status, the second matching information instructs activation of the time-lapse shooting mode. In the time-lapse shooting mode, the camera may shoot at a lower frame rate, allowing dynamic effects in the acceleration process to be presented during subsequent video playback and enabling the user to more clearly perceive the speed variation.

For example, when the driving speed information of the vehicle indicates that the vehicle is deceleration, the second matching information instructs activation of the slow-motion shooting mode. In the slow-motion shooting mode, the frame rate can be increased to capture subtle movements and variations during the deceleration process, making the video image more detailed and refined.

For example, when the driving speed information of the vehicle indicates that the vehicle is in the high-speed driving status, the second matching information instructs activation of the A-times speed shooting mode greater than 1. In the A-times speed shooting mode, the camera shoots at a high-speed frame rate higher than the normal frame rate, allowing for a fast and smooth image during subsequent video playback. In one embodiment, the A-times speed may, for example, be 1.5 times.

For example, when the driving speed information of the vehicle indicates that the vehicle is in the medium-speed driving status, the second matching information instructs activation of the B-times speed shooting mode greater than 1 and less than A. In the B-times speed shooting mode, the camera shoots at a medium frame rate between high speed and normal speed. In this way, the shot video can retain certain details without making the video content overly lengthy.

For example, when the driving speed information of the vehicle indicates that the driving status of the vehicle is in the low-speed driving status, the second matching information instructs activation of the normal shooting mode. In the normal shooting mode, the camera shoots at a standard frame rate, and the shooting can accurately reflect the scenarios and details of the vehicle driving at low speeds.

For example, when the driving speed information of the vehicle indicates that the vehicle is in the braking status, the second matching information instructs activation of the freeze-frame shooting mode. In the freeze-frame shooting mode, the camera may quickly capture the image of the braking moment and freeze the image, allowing for a detailed shooting of the interior conditions and surrounding environment during the braking process.

In the embodiments above, by further defining the second matching information, the apparatus can intelligently select and adjust the shooting mode according to different driving status, thereby providing the user with video content of varying styles.

To make the shooting method of the vehicle camera better align with user needs, in some embodiments, the apparatus 120 for controlling a vehicle camera to generate a video may further modify the corresponding vehicle camera and/or the corresponding shooting mode according to a modification operation of the user. The modification operation of the user may be a page operation, a voice operation, or the like.

In some embodiments, the method for controlling a vehicle camera to generate a video further comprises: acquiring facial recognition information of a vehicle user inside the vehicle; determining a direction of interest of the vehicle user on the basis of the facial recognition information; and when the direction of interest is inconsistent with a shooting direction of the corresponding selected and activated vehicle camera, additionally selecting and activating a vehicle camera whose shooting direction is consistent with the direction of interest.

The “facial recognition information of the vehicle user” involved in the embodiments of the present disclosure may be implemented through a facial recognition technology. In particular, the vehicle interior camera is activated to acquire a facial image of the vehicle user inside the vehicle. The facial image is recognized by the facial recognition software, thereby acquiring the facial recognition information of the vehicle user. It is to be noted that the facial recognition software can be mounted on the in-vehicle terminal or the cloud platform.

The direction of interest of the vehicle user may be the direction primarily focused on by the user within a certain period of time or over a certain distance. The direction of interest of the vehicle user can be inferred from the facial recognition information.

In one embodiment, the facial recognition information of the vehicle user may include, but is not limited to, information such as facial features, head movements, eye gaze, and the like of the vehicle user.

In particular, during driving, the apparatus 120 for controlling a vehicle camera to generate a video may determine the direction of interest of the vehicle user by capturing and analyzing information such as facial features, head movements, eye gaze, and the like of the user. After determining the direction of interest of the vehicle user, the apparatus 120 for controlling a vehicle camera to generate a video may check whether the shooting direction of the currently selected and activated vehicle camera is consistent with the direction of interest. When the shooting direction of the selected and activated vehicle camera is inconsistent with the direction of interest, a vehicle camera with a shooting direction consistent with the direction of interest is additionally selected and activated to shoot for video generation. In this way, this can ensure that the captured video content better aligns with the actual points of interest of the user, thereby enhancing the user experience. Furthermore, by combining the facial recognition information with driving information, the apparatus can gain a more comprehensive understanding of the vehicle status and user status, thereby selecting shooting modes that better align with user expectations. This is not only conducive to enhancing video quality, but also provides users with more personalized and considerate services.

It is to be noted that the shooting method above requires the user to activate an option of facial recognition function. The user can activate the option via page operation or voice operation through the in-vehicle terminal or the user terminal 140.

The apparatus 120 for controlling a vehicle camera to generate a video can not only adjust the shooting method according to the vehicle driving information, but also has a function of generating a panoramic video. In some embodiments, the method for controlling a vehicle camera to generate a video further comprises: entering a panoramic generation mode after acquiring an operation instruction for generating a panoramic video; in the panoramic generation mode, at least activating all vehicle exterior cameras to perform video shooting on the exterior of the vehicle to generate a plurality of videos; and stitching the plurality of videos into a panoramic video using a video stitching algorithm.

In an embodiment of the present disclosure, during driving, the apparatus 120 for controlling a vehicle camera to generate a video enters the panoramic generation mode upon receiving the operation instruction to generate the panoramic video. In the panoramic generation mode, the apparatus 120 for controlling a vehicle camera to generate a video may activate each vehicle exterior camera to perform video shooting. Each camera generates a separate video, wherein each video captures an image from a respective external direction of the vehicle. The apparatus 120 for controlling a vehicle camera to generate a video may stitch the plurality of videos into one panoramic video using the video stitching algorithm. Each frame of the panoramic video may be a coherent and complete image formed by seamlessly stitching together the videos.

In the embodiments above, by generating a panoramic video that comprehensively displays the external environment of the vehicle, a broader field of view can be provided to the user, and the user is enabled to better shoot the scenery surrounding the vehicle.

In one embodiment, in the panoramic generation mode, the apparatus 120 for controlling a vehicle camera to generate a video may further activate the vehicle interior camera to perform video shooting. In this way, the internal environment of the vehicle during driving can be shot.

Furthermore, in the panoramic generation mode, all vehicle exterior cameras may be at least activated to perform video shooting on the exterior of the vehicle according to the corresponding shooting modes to generate a plurality of videos.

In particular, after determining the shooting mode, the apparatus 120 for controlling a vehicle camera to generate a video activates the vehicle cameras to perform video shooting according to the corresponding shooting modes, thereby ensuring that each video can adapt to various vehicle speed scenarios while meeting the requirements for panoramic video generation. This is not only conducive to improving the overall quality of the panoramic video, but also ensures a more natural and smooth transition and integration between the videos.

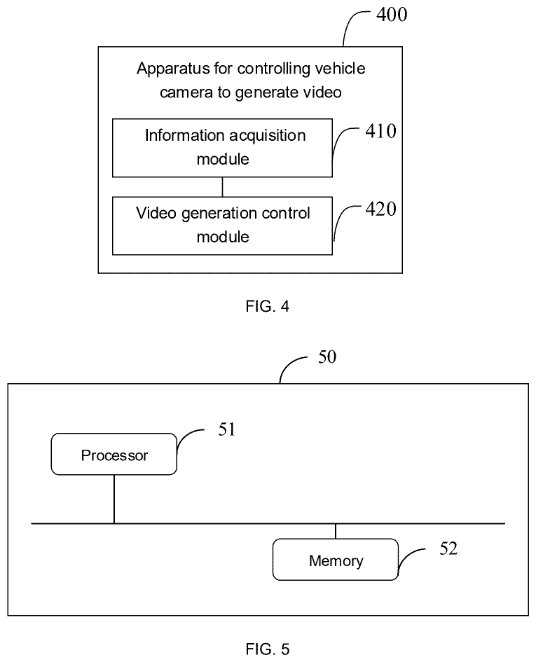

Yet another aspect of the present disclosure provides an apparatus for controlling a vehicle camera to generate a video, which may be located on a vehicle terminal or a cloud platform. FIG. 4 is a schematic structural diagram of an apparatus for controlling a vehicle camera to generate a video according to an embodiment of the present disclosure. As shown in FIG. 4, the apparatus 400 may comprise the following modules:
an information acquisition module 410, configured to acquire driving information of the vehicle and preset matching information, wherein the driving information comprises at least driving direction information and braking status information of the vehicle, and the preset matching information comprises first matching information which defines a matching relationship between the driving direction information and/or braking status information of the vehicle and activation of a corresponding vehicle camera; and
a video generation control module 420, configured to, according to the first matching information, select and activate the corresponding vehicle camera among a plurality of vehicle cameras on the basis of the driving direction information and/or braking status information of the vehicle to shoot an exterior or interior of the vehicle to generate a video.

In some embodiments, the driving information further comprises driving speed information of the vehicle, and the preset matching information comprises second matching information which defines a matching relationship between the driving speed information of the vehicle and activation of a corresponding shooting mode. The apparatus 400 further comprises: a shooting mode activation module, configured to, according to the second matching information, select and activate the corresponding shooting mode among a plurality of shooting modes of the corresponding vehicle camera on the basis of the driving speed information of the vehicle.

In some embodiments, the apparatus 400 further comprises the following modules:
a facial recognition information acquisition module, configured to acquire facial recognition information of a vehicle user inside the vehicle; and
a direction-of-interest determination module, configured to determine a direction of interest of the vehicle user on the basis of the facial recognition information.

The video generation control module is further configured to, when the direction of interest is inconsistent with a shooting direction of the corresponding selected and activated vehicle camera, additionally select and activate a vehicle camera whose shooting direction is consistent with the direction of interest.

In some embodiments, the video generation control module is further configured to:
control to enter a panoramic generation mode after acquiring an operation instruction for generating a panoramic video; and
in the panoramic generation mode at least activate all vehicle exterior cameras to perform video shooting on the exterior of the vehicle to generate a plurality of videos.

The apparatus further comprises a video stitching module which is configured to stitch the plurality of videos into a panoramic video using a video stitching algorithm.

It is to be understood that the specific features, operations, and details described herein foregoing regarding the method of the present disclosure may be similarly applied to the apparatus and system of the present disclosure, or vice versa. Furthermore, each step of the method of the present disclosure described above may be performed by a respective component or unit of the apparatus or system of the present disclosure.

It is to be understood that various modules/units of the apparatus of the present disclosure may be implemented, in whole or in part, through software, hardware, firmware, or a combination thereof. Each module/unit may be embedded in hardware or firmware in the processor of the electronic device, or independent of the processor, or may be stored in software in the memory of the electronic device for the processor to call to perform the operations of each module/unit. Each module/unit may be implemented as an independent component or module, or two or more modules/units may be implemented as a single component or module.

Still another aspect of the present disclosure provides an electronic device. FIG. 5 is a schematic structural diagram of an electronic device according to an embodiment of the present disclosure. As shown in FIG. 5, the electronic device 50 comprises a processor 51 and a memory 52 storing computer program instructions. The processor 51, when executing the computer program instructions, implements steps of the method for controlling a vehicle camera to generate a video described above. The electronic device 50 may broadly be a server, an in-vehicle terminal, or any other electronic device with necessary computing and/or processing capabilities.

In one embodiment, the electronic device 50 may comprise a processor, a memory, a network interface, a communication interface, or the like connected via a system bus. The processor of the electronic device 50 may be configured to provide necessary computing, processing, and/or control capabilities. The memory of the electronic device 50 may comprise a non-volatile storage medium and an internal memory. The non-volatile storage medium may store an operating system, a computer program, and the like. The internal memory may provide an environment for the operation of the operating system and computer program in the non-volatile storage medium. The network interface and communication interface of the electronic device 50 may be configured to connect to and communicate with an external device via a network. The computer program, when executed by the processor, performs steps of the method for controlling a vehicle camera to generate a video according to the present disclosure.

Still another aspect of the present disclosure provides a computer-readable storage medium storing a computer-executable program which, when executed by a processor, implements the steps of the method for controlling a vehicle camera to generate a video described herein.

Still another aspect of the present disclosure provides a vehicle which may comprise a plurality of vehicle cameras and the apparatus for controlling a vehicle camera to generate a video described herein.

Those skilled in the art can appreciate that the method steps of the present disclosure may be performed by a computer program instructing the relevant hardware, such as the electronic device 50 or processor. The computer program may be stored in a non-transitory computer-readable storage medium, and when executed, causes the steps of the present disclosure to be performed. Any reference herein to memory, storage, or other media may comprise non-volatile or volatile memory, as applicable. Examples of the non-volatile memory comprise read-only memory (ROM), programmable ROM (PROM), electrically programmable ROM (EPROM), electrically erasable programmable ROM (EEPROM), flash memory, magnetic tape, floppy disks, magneto-optical data storage devices, optical data storage devices, hard disks, solid-state drives, and the like. Examples of the volatile memory comprise random-access memory (RAM), external cache memory, and the like.

The technical features described above may be arbitrarily combined. Although not all possible combinations of these technical features are described, any combination of these technical features is to be considered as encompassed by this description, provided that such combinations do not contradict each other.

Finally, it is to be noted that the embodiments above are merely provided to illustrate the technical solutions of the present disclosure and are not intended to limit them. Although the present disclosure has been described in detail with reference to the foregoing embodiments, those skilled in the art are to understand that the technical solutions described in the foregoing embodiments can be modified, or part or all of the technical features can be equivalently replaced. However, these modifications or substitutions do not cause the essence of the corresponding technical solutions to deviate from the scope of the technical solutions of the embodiments of the present disclosure.

1. A method for controlling a vehicle camera to generate a video, the method comprising:
acquiring driving information of a vehicle and preset matching information, wherein the driving information comprises at least driving direction information and braking status information of the vehicle, and the preset matching information comprises first matching information which defines a matching relationship between the driving direction information and/or braking status information of the vehicle and activation of a corresponding vehicle camera; and
according to the first matching information, controlling the activation of the corresponding vehicle camera among a plurality of vehicle cameras on the basis of the driving direction information and/or braking status information of the vehicle to shoot an exterior or interior of the vehicle to generate a video.

2. The method according to claim 1, wherein the driving information further comprises driving speed information of the vehicle, and the preset matching information comprises second matching information which defines a matching relationship between the driving speed information of the vehicle and activation of a corresponding shooting mode, the method further comprising:

1. A method for controlling a vehicle camera to generate a video, the method comprising:
acquiring driving information of a vehicle and preset matching information, wherein the driving information comprises at least driving direction information and braking status information of the vehicle, and the preset matching information comprises first matching information which defines a matching relationship between the driving direction information and/or braking status information of the vehicle and activation of a corresponding vehicle camera; and
according to the first matching information, controlling the activation of the corresponding vehicle camera among a plurality of vehicle cameras on the basis of the driving direction information and/or braking status information of the vehicle to shoot an exterior or interior of the vehicle to generate a video.

2. The method according to claim 1, wherein the driving information further comprises driving speed information of the vehicle, and the preset matching information comprises second matching information which defines a matching relationship between the driving speed information of the vehicle and activation of a corresponding shooting mode, the method further comprising:
according to the second matching information, controlling the activation of a corresponding shooting mode among a plurality of shooting modes of the corresponding vehicle camera on the basis of the driving speed information of the vehicle.

3. The method according to claim 1, further comprising:
acquiring facial recognition information of a vehicle user inside the vehicle;
determining a direction of interest of the vehicle user on the basis of the facial recognition information; and
when the direction of interest of the vehicle user is inconsistent with a shooting direction of the corresponding selected and activated vehicle camera, additionally selecting and activating a vehicle camera whose shooting direction is consistent with the direction of interest of the vehicle user.

4. The method according to claim 1, wherein the first matching information defines the matching relationship between the driving direction information and/or braking status information of the vehicle and the activation of the corresponding vehicle camera by:
activating a vehicle left-side camera when the driving direction of the vehicle is a right-turn direction;
activating a vehicle right-side camera when the driving direction of the vehicle is a left-turn direction;
activating a vehicle rear-side camera when the driving direction of the vehicle is a reverse direction;
activating a vehicle front-side camera when the driving direction of the vehicle is a forward direction; or
activating a vehicle interior camera when the vehicle is in a braking status.

5. The method according to claim 2, wherein the second matching information defines the matching relationship between the driving speed information of the vehicle and the activation of the corresponding shooting mode by:
activating a time-lapse shooting mode when the driving status is acceleration;
activating a slow-motion shooting mode when the driving status is deceleration;
activating an A-times speed shooting mode when the driving status is high-speed driving wherein A is greater than 1;
activating a B-times speed shooting mode when the driving status is medium-speed driving, wherein B is greater than 1 and less than A;
activating a normal shooting mode when the driving status is low-speed driving; or
activating a freeze-frame shooting mode when the driving status is a braking status.

6. The method according to claim 1, further comprising:
controlling to enter a panoramic generation mode after acquiring an operation instruction for generating a panoramic video;
in the panoramic generation mode, at least activating all vehicle exterior cameras to perform video shooting on the exterior of the vehicle to generate a plurality of videos; and
stitching the plurality of videos into a panoramic video using a video stitching algorithm.

7. An apparatus for controlling a vehicle camera to generate a video, the apparatus comprising:
an information acquisition module, configured to acquire driving information of a vehicle and preset matching information, wherein the driving information comprises at least driving direction information and braking status information of the vehicle, and the preset matching information comprises first matching information which defines a matching relationship between the driving direction information and/or braking status information of the vehicle and activation of a corresponding vehicle camera; and
a video generation control module, configured to, according to the first matching information, control the activation of the corresponding vehicle camera among a plurality of vehicle cameras on the basis of the driving direction information and/or braking status information of the vehicle to shoot an exterior or interior of the vehicle to generate a video.

8. The apparatus according to claim 7, wherein the driving information further comprises driving speed information of the vehicle, and the preset matching information comprises second matching information which defines a matching relationship between the driving speed information of the vehicle and activation of a corresponding shooting mode, the apparatus further comprising:
a shooting mode activation module, configured to, according to the second matching information, select and activate a corresponding shooting mode among a plurality of shooting modes of the corresponding vehicle camera on the basis of the driving speed information of the vehicle.

9. The apparatus according to claim 7, further comprising:
a facial recognition information acquisition module, configured to acquire facial recognition information of a vehicle user inside the vehicle; and
a user direction-of-interest determination module, configured to determine a direction of interest of the vehicle user on the basis of the facial recognition information;
wherein the video generation control module is further configured to, when the direction of interest of the vehicle user is inconsistent with a shooting direction of the corresponding selected and activated vehicle camera, additionally select and activate a vehicle camera whose shooting direction is consistent with the direction of interest of the vehicle user.

10. The apparatus according to claim 7, wherein the first matching information defines the matching relationship between the driving direction information and/or braking status information of the vehicle and the activation of the corresponding vehicle camera by:
activating a vehicle left-side camera when the driving direction of the vehicle is a right-turn direction;
activating a vehicle right-side camera when the driving direction of the vehicle is a left-turn direction;
activating a vehicle rear-side camera when the driving direction of the vehicle is a reverse direction;
activating a vehicle front-side camera when the driving direction of the vehicle is a forward direction; or
activating a vehicle interior camera when the vehicle is in a braking status.

11. The apparatus according to claim 8, wherein the second matching information defines the matching relationship between the driving speed information of the vehicle and the activation of the corresponding shooting mode by:
activating a time-lapse shooting mode when the driving status is acceleration;
activating a slow-motion shooting mode when the driving status is deceleration;
activating an A-times speed shooting mode when the driving status is high-speed driving, wherein A is greater than 1;
activating a B-times speed shooting mode when the driving status is medium-speed driving, wherein B is greater than 1 and less than A;
activating a normal shooting mode when the driving status is low-speed driving; or activating a freeze-frame shooting mode when the driving status is a braking status.

12. The apparatus according to claim 7, wherein
the video generation control module is further configured to:
control to enter a panoramic generation mode after acquiring an operation instruction for generating a panoramic video; and
in the panoramic generation mode, at least activate all vehicle exterior cameras to perform video shooting on the exterior of the vehicle to generate a plurality of videos; and
the apparatus further comprises a video stitching module which is configured to stitch the plurality of videos into a panoramic video using a video stitching algorithm.

13. A system for controlling a vehicle camera to generate a video, wherein the system comprises at least a cloud platform and an apparatus for controlling a vehicle camera to generate a video according to claim 7.

14. An electronic device, comprising a processor and a memory storing computer program instructions which, when executed by the processor, implement the steps of a method for controlling a vehicle camera to generate a video according to claim 1.

15. A non-transitory computer-readable storage medium storing a computer-executable program which, when executed by a processor, implements the steps of a method for controlling a vehicle camera to generate a video according to claim 1.

16. A vehicle, comprising a plurality of vehicle cameras and an apparatus for controlling a vehicle camera to generate a video according to claim 7.
